(19) United States
(12) Patent Application Publication
(10) Pub. No.: US 2025/0104073 A1
(43) Pub. Date: Mar. 27, 2025

(54) SYSTEM AND METHOD FOR IMPROVING ACCURACY IN FRAUD DETECTION

(71) Applicant: Mastercard International Incorporated, Purchase, NY (US)

(72) Inventors: Jose Qiu Chou, San Leandro, CA (US); Michael Lee, Burlingame, CA (US); Douglas Roche, Santa Clara, CA (US); Fariborz Nadi, Fairfield, CA (US); Athena Stacy-Nieto, Edinburg, TX (US)

(73) Assignee: Mastercard International Incorporated, Purchase, NY (US)

(21) Appl. No.: 18/471,853

(22) Filed: Sep. 21, 2023

(51) Int. Cl. G06Q 20/40; G06N 20/00

(52) U.S. Cl. CPC G06Q 20/4016; G06N 20/00

(57) ABSTRACT

A system and method for improving the accuracy of fraud detection in transactions for a more effective fraud response. First and second models each receive transaction request data, evaluate the transaction request data for fraud, and produce first and second initial fraud results, respectively. The first model includes a first set of features which is relevant to detecting fraud and which includes one or more dominant features. The second model includes a second set of features which excludes the one or more dominant features. A score generator receives and combines the first and second initial results to generate a final fraud score. A response module takes an action based on the final score, such as rejecting or allowing the transaction request. The first and second models may use the same or different machine learning or other modeling technologies. The score generator may be a combination module or a combination model.

### FIELD

The present invention relates to systems and methods for detecting fraud in transactions, and more particularly, embodiments concern a system and method for improving the accuracy of fraud detection in transactions by balancing features and combining the results of multiple fraud detection models to arrive at a more accurate fraud score which allows for a more effective fraud response.

### BACKGROUND

Machine learning models to detect fraudulent credit card transactions can be overly sensitive to the values of two or three out of hundreds of features considered by the models. For example, the number of days a merchant has been open may dominate a model, with newer merchants being more strongly associated with fraud, or the age of an account may dominate a model, with newer accounts being more strongly associated with fraud. While such dominant features are important indicators of the risk of fraud, their dominance can result in oversensitivity and inaccurate fraud scores.

This background discussion is intended to provide information related to the present invention which is not necessarily prior art.

### SUMMARY

Embodiments address the above-described and other problems and limitations in the prior art by providing a system and method for improving the accuracy of fraud detection in transactions by balancing features and combining the results of multiple fraud detection models to arrive at a more accurate fraud score which allows for a more effective fraud response. In various implementations, the models may be identical but for their feature sets and/or may use the same or different machine learning model or other modeling technology.

In a first embodiment of the present invention, a system is provided for improving the accuracy of fraud detection and enabling a more effective fraud response. The system may include a requesting entity, a first model, a second model, a score generator, and a response module. The requesting entity may transmit a transaction request including a transaction request data. The first model may be trained on relevant data and include a first set of features which are relevant to detecting fraud, the first set of features may include one more dominant features, and the first model may receive the transaction request data, evaluate the transaction request data for fraud, and produce a first initial fraud result. The second model may be trained on the relevant data and include a second set of features which are relevant to detecting fraud, the second set of features may exclude the one or more dominant features, and the second model may receive the transaction request data, evaluate the transaction request data for fraud, and produce a second initial fraud result. The score generator may combine the first and second initial fraud results to generate a final fraud score. The response module may receive the final fraud score and take an action based on the fraud score, wherein the action may include rejecting or allowing the transaction request from the requesting entity.

In various implementations, the above-described first embodiment may include any one or more of the following additional or alternative features. The first model may be based on a first modeling technology and the second model may be based on a second modeling technology which may be the same as or different from the first modeling technology. The score generator may be a combination module further determining a first weight to apply to the first initial fraud result to produce a weighted first initial fraud result, determining a second weight to apply to the second initial fraud result to produce a weighted second initial fraud result, and then combining the weighted first initial fraud result and the weighted second initial fraud result to generate the final fraud score

The score generator may be a combination model which is trained, receives the first and second initial fraud results, and combines the first and second initial fraud results to generate the final fraud score. The combination model may be based on a boosted tree modeling technology. The combination model may further determine a first weight to apply to the first initial fraud result to produce a weighted first initial fraud result, determine a second weight to apply to the second initial fraud result to produce a weighted second initial fraud result, and then combine the weighted first initial fraud result and the weighted second initial fraud result to generate the final fraud score. The combination model may further receive one or fields from the first and second models and generate the final fraud score by combining the one or more fields, the weighted first initial fraud result, and the weighted second initial fraud result.

In a second embodiment of the present invention, a method is provided for improving the accuracy of fraud detection and enabling a more effective fraud response. The method may include the following steps. A first model may be trained on relevant data, the first model may include a first set of features which are relevant to detecting fraud, and the first set of features may include one more dominant features. A second model may be trained on the relevant data, the second model may include a second set of features which are relevant to detecting fraud, and the second set of features may exclude the one or more dominant features. A transaction request may be received from a requesting entity, and the transaction request may include a transaction request data. The transaction request data may be evaluated for fraud by the first model, and a first initial fraud result may be produced by the first model. The transaction request data may be evaluated for fraud by the second model, and a second initial fraud result may be produced by the second model. The first and second initial fraud results may be combined by a score generator to generate a final fraud score. An action may be taken by a response module based on the fraud score, wherein the action may include rejecting or allowing the transaction request from the requesting entity.

In various implementations, the above-described first embodiment may include any one or more of the following additional or alternative features. The first model may be based on a first modeling technology and the second model may be based on a second modeling technology which may be the same as or different from the first modeling technology. The score generator may be a combination module further determining a first weight to apply to the first initial fraud result to produce a weighted first initial fraud result, determining a second weight to apply to the second initial fraud result to produce a weighted second initial fraud result, and then combining the weighted first initial fraud result and the weighted second initial fraud result to generate the final fraud score

The score generator may be a combination model which is trained, receives the first and second initial fraud results, and combines the first and second initial fraud results to generate the final fraud score. The combination model may be based on a boosted tree modeling technology. The combination model may further determine a first weight to apply to the first initial fraud result to produce a weighted first initial fraud result, determine a second weight to apply to the second initial fraud result to produce a weighted second initial fraud result, and then combine the weighted first initial fraud result and the weighted second initial fraud result to generate the final fraud score. The combination model may further receive one or fields from the first and second models and generate the final fraud score by combining the one or more fields, the weighted first initial fraud result, and the weighted second initial fraud result.

This summary is not intended to identify essential features of the present invention, and is not intended to be used to limit the scope of the claims. These and other aspects of the present invention are described below in greater detail.

### BRIEF DESCRIPTION OF DRAWINGS

Embodiments of the present invention are described in detail below with reference to the attached drawing figures, wherein:

FIG. 1 is a block diagram of a first embodiment of a system for balancing features by combining the results of multiple fraud detection models to arrive at a more accurate fraud score which allows for a more effective fraud response, wherein the results are combined by a combination module;

FIG. 2 is a depiction of a first set of features which may be used by a first one of the fraud detection models of FIG. 1, wherein the first set of features includes one or more dominant features;

FIG. 3 is a depiction of a second set of features which may be used by a second one of the fraud detection models of FIG. 1, wherein the second set of features does not include the one or more dominant features;

FIG. 4 is a flowchart of steps in a first embodiment of a method for balancing features by combining the results of multiple fraud detection models to arrive at a more accurate fraud score which allows for a more effective fraud response, wherein the results are combined by a combination model.

FIG. 5 is a block diagram of a second embodiment of a system for balancing features by combining the results of multiple fraud detection models to arrive at a more accurate fraud score which allows for a more effective fraud response, wherein the results are combined by a combination model;

FIG. 6 is a block diagram of an implementation of the system of FIG. 4; and

FIG. 7 is a flowchart of steps in an second embodiment of a method for balancing features by combining the results of multiple fraud detection models to arrive at a more accurate fraud score which allows for a more effective fraud response, wherein the results are combined by a combination model.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment.” or “embodiments” mean that the feature or features referred to are included in at least one embodiment of the invention. Separate references to “one embodiment,” “an embodiment.” or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly, embodiments provide a system and method for improving the accuracy of fraud detection in transactions by balancing features and combining the results of multiple fraud detection models to improve stability and reduce false positives and otherwise arrive at a more accurate fraud score which allows for a more effective fraud response. In various implementations, the models may be identical but for their feature sets and/or may use the same or different machine learning model or other modeling technology.

In a first embodiment, a system and method may be provided for improving the accuracy of fraud detection in transactions and enabling a more effective fraud response by training and executing a first model which includes a set of features and produces a first initial fraud result, training and executing a second model which removes a subset of the most dominant features from the set of features and produces a second initial fraud result, and then combining the first and second initial fraud results using a combination module to arrive at a final fraud score which is more valid and reliable than either of the initial fraud results and which can enable a more effective fraud response. Potential applications include credit card fraud detection, credit risk detection, and healthcare fraud, waste, and abuse detection.

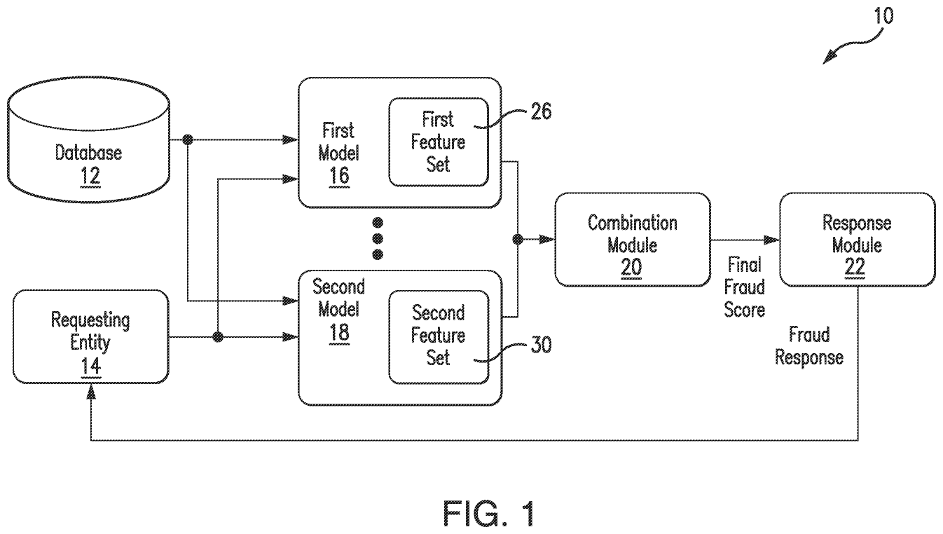

Referring to FIG. 1-3, a first embodiment of a system 10 for improving the accuracy of fraud detection and enabling a more effective fraud response may include a database 12, a requesting entity 14, a first model 16, a second model 18, a score generator in the form of a combination module 20, and a response module 22. The database 12 may contain various data which are relevant to the application at issue (e.g., merchant data, accountholder data, account data, past transaction data). In particular, the data may inform feature sets used by the first and second models 16,18. The requesting entity 14 may transmit a transaction request including transaction request data which is desirable to evaluate for potential fraud. The natures of the requesting entity, the transaction request, and the transaction request data may depend on the particular application at issue.

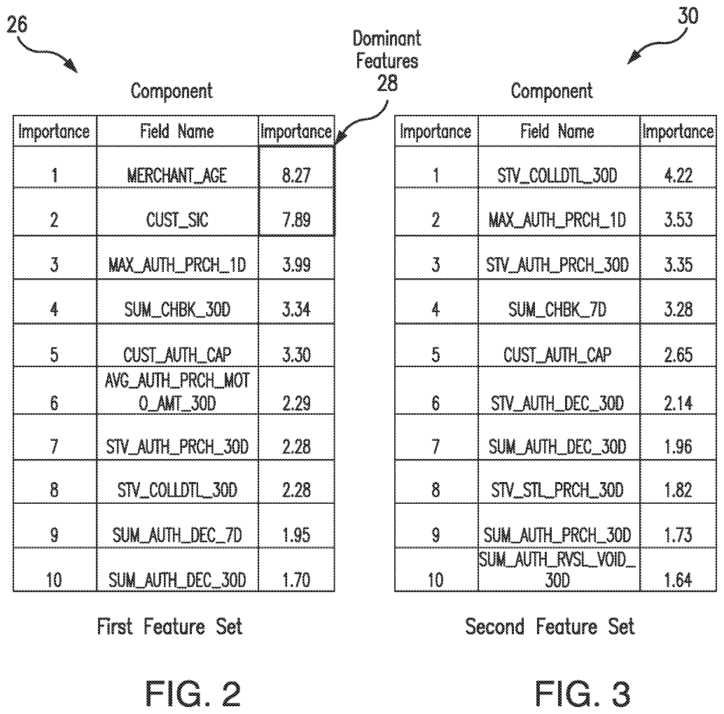

The first model 16 may include a first set of features 26 which are relevant to detecting fraud in the transaction request, and may be trained using the data in the database 12 to detect such fraud. Referring particularly to FIG. 2, the first set of features 26 may include one more dominant features 28. A “dominant feature” is one with relatively high importance or weight in that it has been determined to be relatively more predictive of, in this case, fraud. For example, in FIG. 2, the most dominant feature is the age of the merchant, MERCHANT_AGE, with newer merchants being more strongly correlated with fraud than more established merchants. Thus, the dominant features are those with the strongest correlations with fraud. It will be appreciated that the dominant features may vary depending on the nature of the transaction at issue (e.g., credit card fraud versus healthcare billing fraud), and may even vary over time for the same kind of transaction. In operation, the first model 16 may receive the transaction request data from the requesting entity 14, evaluate the data for fraud, and produce a first initial fraud result. The first model may be based on a first machine learning or other modeling technology which may be substantially any suitable modeling technology.

The second model 18 may include a second set of features 30 which are relevant to detecting fraud in the transaction request, and may be trained using the data in the database 12 to detect such fraud. Referring particularly to FIG. 3, the second set of features 30 may exclude the one or more dominant features 28 of the first set of features 26 but otherwise be identical to the first set of features 26. For example, in FIG. 3, the most dominant features 28 of the first feature set 26, including MERCHANT_AGE, have been removed. The result is that the remaining most dominant features of the second feature set have substantially less relative correlation with fraud, but, as discussed, this ameliorates the otherwise overwhelming impact of the most dominant features of the first feature set in predicting fraud. In operation, the second model 18 may receive the transaction request data from the requesting entity 14, evaluate the data for fraud, and produce a second initial fraud result. The second model may be based on a second machine learning or other modeling technology which may be substantially any suitable modeling technology. In various implementations, the first and second models may use the same, similar, or different modeling technologies. Although “first” and “second” models are referred to for the purpose of describing the system 10, the system may make use of any plural number, i.e., two or more, of such models.

The combination module 20 may receive the first and second initial fraud results and combine them to generate a final fraud score. In one implementation, the final fraud score may be generated, at least in part, by adding the first initial fraud result and the second initial fraud result. In one implementation, the combination module 20 may use a mathematical function to combine the first and second initial fraud results. In the second embodiment of the system 210, described below, the score generator may be in the form of a combination model 220 which may use a machine learning model (e.g., a boosted tree model) or other model to perform substantially the same function of combining the first and second initial fraud results.

The combination module 20 may further determine a first weight to apply to the first initial fraud result to produce a weighted first initial fraud result, determine a second weight to apply to the second initial fraud result to produce a weighted second initial fraud result, and then generate the final fraud score as a function of the weighted first initial fraud result or score and the weighted second initial fraud result. For example, the final fraud score may be generated by the combination module 20 by adding the weighted first fraud result and the weighted second fraud result as follows: Final_score=weight_1*first_result+weight_2*second_result, where weight_1+weight_2=1.

The response module 22 may receive the final fraud score and based thereon take appropriate fraud response action. For example, if the final fraud score indicates a fraudulent transaction then the response module 22 may initiate an appropriate fraud response which may include rejecting the transaction request from the requesting entity 14 and/or suspending an account or one or more privileges of the requesting entity 14. Alternatively, if the final fraud score indicates a non-fraudulent transaction then the response module 22 may initiate an appropriate response which may include allowing the transaction request from the requesting entity 14.

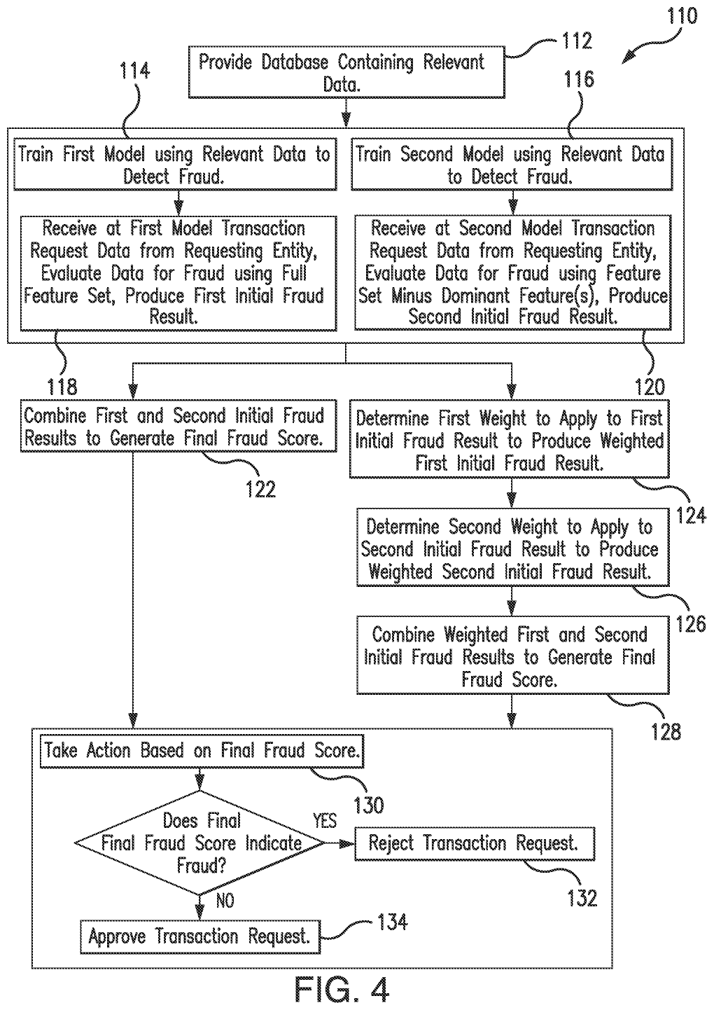

Referring to FIG. 4, a first embodiment of a method 110 for improving the accuracy of fraud detection and enabling a more effective fraud response may include the following steps. The method 110 may be implemented using components of the system 10 and/or reflect operation of the system 10 described above. A database 12 may be provided containing various data which are relevant to the application at issue (e.g., merchant data, accountholder data, account data, past transaction data), as shown in 112.

A first model 16 may be trained using the data in the database 12 to detect fraud, as shown in 114. The first model 16 may include a first set of features which are relevant to detecting fraud, and the first set of features may include one more dominant features. The first model may be based on a first technology which may be substantially any suitable machine learning technology. A second model 18 may be trained using the data in the database to detect fraud, as shown in 116. The second model 16 may include a second set of features which are relevant to detecting fraud, and the second set of features may exclude the one or more dominant features but otherwise be identical to the first set of features.

A requesting entity may transmit a transaction request including transaction request data which is desirable to evaluate for potential fraud. The first model 16 may receive the transaction request data from the requesting entity 14, evaluate the data for fraud, and produce a first initial fraud result, as shown in 118.

The second model 18 may receive the transaction request data from the requesting entity 14, evaluate the data for fraud, and produce a second initial fraud result, as shown in 120. The second model may be based on a first technology which may be substantially any suitable machine learning technology. In various implementations, the first and second models may use the same technology or different technologies.

A combination module 20 may receive the first and second initial fraud results and combine them to generate a final fraud score, as shown in 122. In one implementation, the final fraud score may be generated, at least in part, by adding the first initial fraud result and the second initial fraud result. The combination module 20 may further determine a first weight to apply to the first initial fraud result to produce a weighted first initial fraud result, as shown in 124, determine a second weight to apply to the second initial fraud result to produce a weighted second initial fraud result, as shown in 126, and then generate the final fraud score as a function of the weighted first initial fraud result and the weighted second initial fraud result, as shown in 128.

A response module 22 may receive the final fraud score and based thereon take appropriate fraud response action, as shown in 130. In particular, if the final fraud score indicates a fraudulent transaction then the response module 22 may initiate an appropriate fraud response, as shown in 132, which may include rejecting the transaction request from the requesting entity 14. Alternatively, if the final fraud score indicates a non-fraudulent transaction then the response module 22 may initiate an appropriate response, as shown in 134, which may include allowing the transaction request from the requesting entity 14.

In a second embodiment, a system and method may be provided for improving the accuracy of fraud detection in transactions and enabling a more effective fraud response by training and executing a first model which includes a set of features and produces a first initial fraud result, training and executing a second model which removes a subset of the most dominant features from the set of features and produces a second initial fraud result, and then combining the first and second initial fraud results using a combination model to arrive at a final fraud score which is more valid and reliable than either of the initial fraud results and which can enable a more effective fraud response. Potential applications include credit card fraud detection, credit risk detection, and healthcare fraud, waste, and abuse detection.

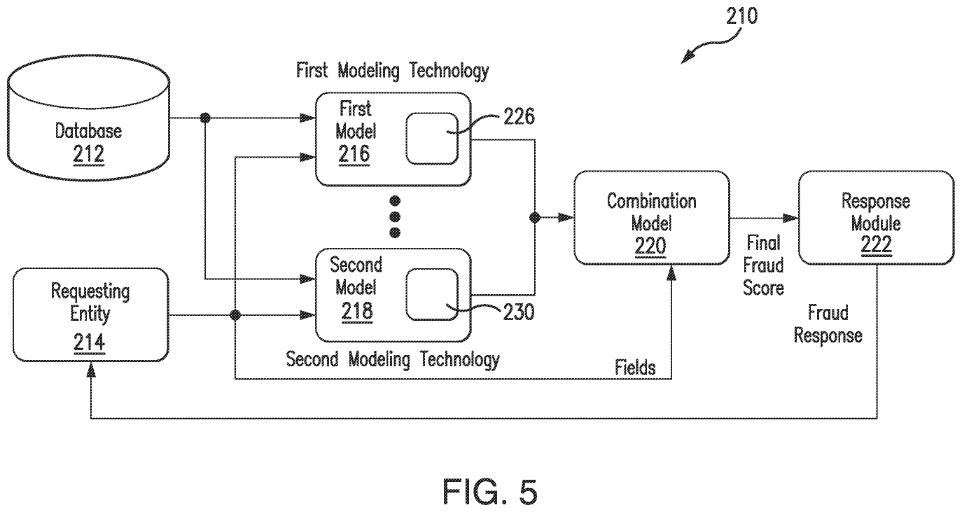

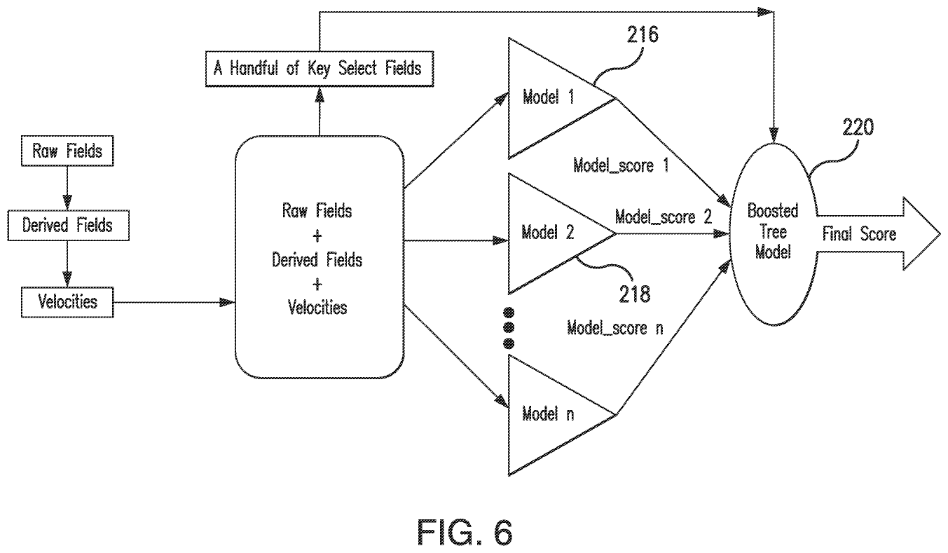

Referring to FIGS. 5 and 6, a second embodiment of a system 210 for improving the accuracy of fraud detection and enabling a more effective fraud response may include a database 212, a requesting entity 214, a first model 216, a second model 218, a score generator in the form of a combination model 220, and a response module 222. The database 212 may contain various data which are relevant to the application at issue (e.g., merchant data, accountholder data, account data, past transaction data). In particular, the data may inform feature sets used by the first and second models 216,218. The requesting entity 214 may transmit a transaction request including transaction request data which it is desirable to evaluate for potential fraud. The natures of the requesting entity, the transaction request, and the transaction request data may depend on the particular application at issue.

The first model 216 may include a first set of features 226 which are relevant to detecting fraud in the transaction request, and may be trained using the data in the database 212 to detect such fraud. Recalling FIG. 2, the first set of features 226 may include one more dominant features. In operation, the first model 216 may receive the transaction request data from the requesting entity 214, evaluate the data for fraud, and produce a first initial fraud result. The first model may be based on a first machine learning or other modeling technology which may be substantially any suitable modeling technology.

The second model 218 may include a second set of features 230 which are relevant to detecting fraud in the transaction request, and may be trained using the data in the database 212 to detect such fraud. Referring again to FIG. 3, the second set of features 230 may exclude the one or more dominant features of the first set of features 226 but otherwise be identical to the first set of features 226. In operation, the second model 218 may receive the transaction request data from the requesting entity 214, evaluate the data for fraud, and produce a second initial fraud result. The second model may be based on a second machine learning or other modeling technology which may be substantially any suitable modeling technology. In various implementations, the first and second models may use the same, similar, or different modeling technologies. Each technology has different strengths and weaknesses, so using models based on different technologies and combining the results may provide results that are more stable, more robust, and less sensitive to noise and generally better for some applications. Although “first” and “second” models are referred to for the purpose of describing the system 210, the system may make use of any plural number, i.e., two or more, of such models.

The combination model 220 may be trained, receive the first and second initial fraud results, and combine them to generate a final fraud result. In various implementations, the combination model 220 may use the same or different machine learning or other modeling technologies as the first and/or second models. In one implementation, the combination model 220 may be a boosted tree model. The combination model 220 may further determine a first weight to apply to the first initial fraud result to produce a weighted first initial fraud result, determine a second weight to apply to the second initial fraud result to produce a weighted second initial fraud result, and generate the final fraud score as a function of the weighted first initial fraud result and the weighted second initial fraud result. In one implementation, the combination model 220 may further receive one or more first fields from the first model 216 and one or more second fields from the second model 218, and may generate the final fraud score as a function of the first and second fields, the weighted first initial fraud result, and the weighted second initial fraud result. As shown in FIG. 6, the one or more fields may be selected from raw fields, derived fields, and/or velocities and/or substantially any other suitable fields.

The response module 222 may receive the final fraud score and based thereon take appropriate fraud response action. For example, if the final fraud score indicates a fraudulent transaction then the response module 222 may initiate an appropriate fraud response which may include rejecting the transaction request from the requesting entity 14 and/or suspending an account or one or more privileges of the requesting entity 214. Alternatively, if the final fraud score indicates a non-fraudulent transaction then the response module 222 may initiate an appropriate response which may include allowing the transaction request from the requesting entity 214.

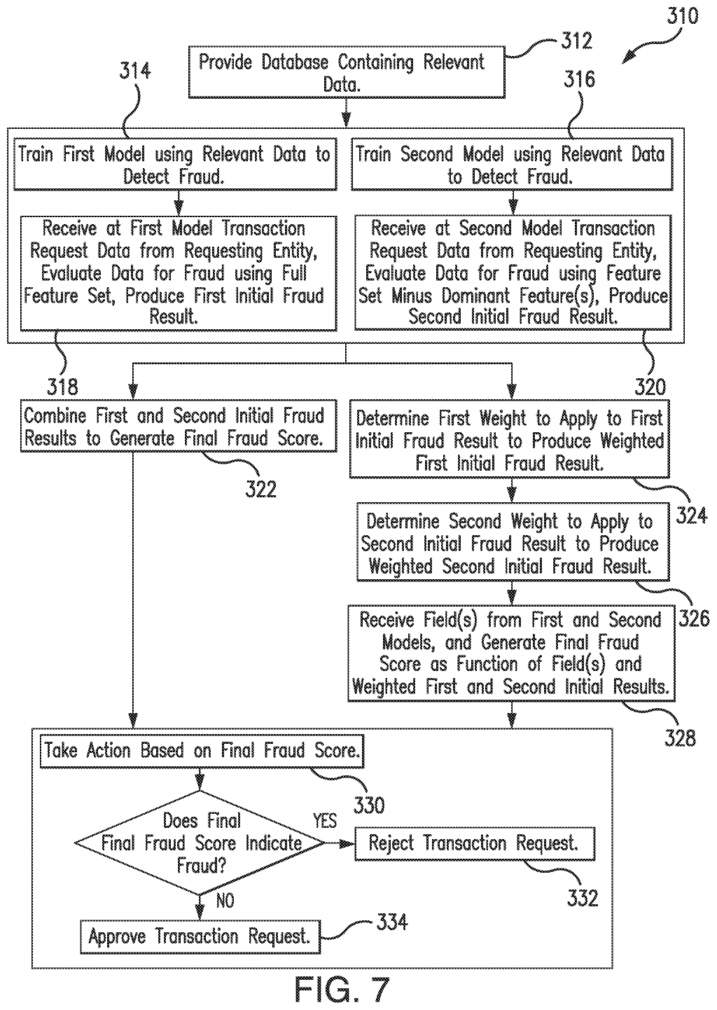

Referring to FIG. 7, a second embodiment of a method 310 for improving the accuracy of fraud detection and enabling a more effective fraud response may include the following steps. The method 310 may be implemented using components of the system 210 and/or reflect operation of the system 210 described above. A database 212 may be provided containing various data which are relevant to the application at issue (e.g., merchant data, accountholder data, account data, past transaction data), as shown in 312.

A first model 216 may be trained using the data in the database 212 to detect fraud, as shown in 314. The first model 216 may include a first set of features which are relevant to detecting fraud, and the first set of features may include one more dominant features. The first model may be based on a first technology which may be substantially any suitable machine learning technology. A second model 218 may be trained using the data in the database to detect fraud, as shown in 316. The second model 216 may include a second set of features which are relevant to detecting fraud, and the second set of features may exclude the one or more dominant features but otherwise be identical to the first set of features.

A requesting entity may transmit a transaction request including transaction request data which it is desirable to evaluate for potential fraud. The first model 216 may receive the transaction request data from the requesting entity 214, evaluate the data for fraud, and produce a first initial fraud result, as shown in 318. The second model 218 may receive the transaction request data from the requesting entity 214, evaluate the data for fraud, and produce a second initial fraud result, as shown in 320. The second model may be based on a first technology which may be substantially any suitable machine learning technology. In various implementations, the first and second models may use the same technology or different technologies.

A combination model 220 may be trained, receive the first and second initial fraud results, and combine them to generate a final fraud score, as shown in 322. In various implementations, the combination model 220 may use the same or different technologies as the first and/or second models. In one implementation, the combination model 220 may be a boosted tree model. The combination model 220 may further determine a first weight to apply to the first initial fraud result to produce a weighted first initial fraud result, as shown in 324, determine a second weight to apply to the second initial fraud result to produce a weighted second initial fraud result, as shown in 326, and generate the final fraud score as a function of the weighted first initial fraud result and the weighted second initial fraud result. In one implementation, the combination model 220 may also receive one or more fields from the first and second models 216,218, and may generate the final fraud score as a function of the one or more fields, the weighted first initial fraud result and the weighted second initial fraud result, as shown in 328.

A response module 222 may receive the final fraud score and based thereon take appropriate fraud response action, as shown in 330. In particular, if the final fraud score indicates a fraudulent transaction then the response module 222 may initiate an appropriate fraud response, as shown in 332, which may include rejecting the transaction request from the requesting entity 214. Alternatively, if the final fraud score indicates a non-fraudulent transaction then the response module 222 may initiate an appropriate response, as shown in 334, which may include allowing the transaction request from the requesting entity 214.

### Additional Considerations

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

As used herein, the term “cardholder” may refer to the owner or rightful possessor of a payment card. As used herein, the term “cardholder account” may refer specifically to a PAN or more generally to an account a cardholder has with the payment card issuer and that the PAN is or was associated with. As used herein, the term “merchant” may refer to a business, a charity, or any other such entity that can generate transactions with a cardholder account through a payment card network.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at separate times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at separate times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed. at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a specific location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for improving the accuracy of fraud detection and enabling a more effective fraud response, the system comprising:
a requesting entity transmitting a transaction request including a transaction request data;
a first model trained on relevant data and including a first set of features which are relevant to detecting fraud, the first set of features including one more dominant features, and the first model receiving the transaction request data, evaluating the transaction request data for fraud, and producing a first initial fraud result;
a second model trained on the relevant data and including a second set of features which are relevant to detecting fraud, the second set of features excluding the one or more dominant features, and the second model receiving the transaction request data, evaluating the transaction request data for fraud, and producing a second initial fraud result;
a score generator combining the first and second initial fraud results to generate a final fraud score; and
a response module receiving the final fraud score and taking an action based on the final fraud score, wherein the action includes rejecting or allowing the transaction request from the requesting entity.

2. The system of claim 1, wherein the first model is based on a first modeling technology and the second model is based on a second modeling technology which is the same as the first modeling technology.

3. The system of claim 1, wherein the first model is based on a first modeling technology and the second model is based on a second modeling technology which is different from the first modeling technology.

4. The system of claim 1, wherein the score generator is a combination module further determining a first weight to apply to the first initial fraud result to produce a weighted first initial fraud result, determining a second weight to apply to the second initial fraud result to produce a weighted second initial fraud result, and then combining the weighted first initial fraud result and the weighted second initial fraud result to generate the final fraud score.

5. The system of claim 1, wherein the score generator is a combination model which is trained, receives the first and second initial fraud results, and combines the first and second initial fraud results to generate the final fraud score.

6. The system of claim 5, wherein the combination model is based on a boosted tree modeling technology.

7. The system of claim 5, the combination model further determining a first weight to apply to the first initial fraud result to produce a weighted first initial fraud result, determining a second weight to apply to the second initial fraud result to produce a weighted second initial fraud result, and then combining the weighted first initial fraud result and the weighted second initial fraud result to generate the final fraud score.

8. The system of claim 5, the combination model further receiving one or more fields from the first and second models and generating the final fraud score by combining the one or more fields, the weighted first initial fraud result, and the weighted second initial fraud result.

9. A system for improving the accuracy of fraud detection in electronic financial transactions and enabling a more effective fraud response, the system comprising:
a requesting entity transmitting a transaction request including a transaction request data;
a first model trained on relevant data and including a first set of features which are relevant to detecting fraud, the first set of features including one more dominant features, and the first model receiving the transaction request data, evaluating the transaction request data for fraud, and producing a first initial fraud result;
a second model trained on the relevant data and including a second set of features which are relevant to detecting fraud, the second set of features excluding the one or more dominant features, and the second model receiving the transaction request data, evaluating the transaction request data for fraud, and producing a second initial fraud result,
wherein the first model and the second model are both based on the same modeling technology;
a score generator combining the first and second initial fraud results to generate a final fraud score; and
a response module receiving the final fraud score and taking an action based on the final fraud score, wherein the action includes rejecting or allowing the transaction request from the requesting entity.

10. The system of claim 9, wherein the score generator is a combination module further determining a first weight to apply to the first initial fraud result to produce a weighted first initial fraud result, determining a second weight to apply to the second initial fraud result to produce a weighted second initial fraud result, and then adding the weighted first initial fraud result and the weighted second initial fraud result to generate the final fraud score.

11. The system of claim 9, wherein the score generator is a combination model based on a boosted tree modeling technology and which is trained, receives the first and second initial fraud results, and combines the first and second initial fraud results to generate the final fraud score.

12. The system of claim 11, the combination model further determining a first weight to apply to the first initial fraud result to produce a weighted first initial fraud result, determining a second weight to apply to the second initial fraud result to produce a weighted second initial fraud result, and receiving one or more fields from the first and second models and generating the final fraud score by combining the one or more fields, the weighted first initial fraud result, and the weighted second initial fraud result.

13. A method for improving the accuracy of fraud detection and enabling a more effective fraud response, the method comprising:
training a first model on relevant data, the first model including a first set of features which are relevant to detecting fraud, the first set of features including one more dominant features;
training a second model on the relevant data, the second model including a second set of features which are relevant to detecting fraud, the second set of features excluding the one or more dominant features;
receiving a transaction request from a requesting entity, the transaction request including a transaction request data;
evaluating with the first model the transaction request data for fraud, and producing with the first model a first initial fraud result;
evaluating with the second model the transaction request data for fraud, and producing with the second model a second initial fraud result;
combining the first and second initial fraud results with a score generator to generate a final fraud score; and
taking an action by a response module based on the final fraud score, wherein the action includes rejecting or allowing the transaction request from the requesting entity.

14. The method of claim 13, wherein the first model is based on a first modeling technology and the second model is based on a second modeling technology which is the same as the first modeling technology.

15. The method of claim 13, wherein the first model is based on a first modeling technology and the second model is based on a second modeling technology which is different from the first modeling technology.

16. The method of claim 13, wherein the score generator is a combination module further determining a first weight to apply to the first initial fraud result to produce a weighted first initial fraud result, determining a second weight to apply to the second initial fraud result to produce a weighted second initial fraud result, and then combining the weighted first initial fraud result and the weighted second initial fraud result to generate the final fraud score.

17. The method of claim 13, wherein the score generator is a combination model which is trained, receives the first and second initial fraud results, and combines the first and second initial fraud results to generate the final fraud score.

18. The method of claim 17, wherein the combination model is based on a boosted tree modeling technology.

19. The method of claim 17, the combination model further determining a first weight to apply to the first initial fraud result to produce a weighted first initial fraud result, determining a second weight to apply to the second initial fraud result to produce a weighted second initial fraud result, and then combining the weighted first initial fraud result and the weighted second initial fraud result to generate the final fraud score.

20. The method of claim 17, the combination model further receiving one or more fields from the first and second models and generating the final fraud score by combining the one or more fields, the weighted first initial fraud result, and the weighted second initial fraud result.
